(19) United States
(12) Patent Application Publication
(10) Pub. No.: US 2023/0006433 A1
(43) Pub. Date: Jan. 5, 2023

(54) LINE GUIDE DEVICE AND MODULAR END FASTENINGS WITH FLEXIBLE ENVELOPE FOR CLEAN ROOM APPLICATIONS

(71) Applicant: IGUS GMBH, Koeln (DE)

(72) Inventors: Andreas HERMEY, Hennef (DE); Dominik BARTEN, Meckenheim (DE); Peter MATTONET, Kuerten (DE)

(21) Appl. No.: 17/757,243

(22) PCT Filed: Dec. 10, 2020
(86) PCT No.: PCT/EP2020/085610

§ 371 Date: Jun. 13, 2022

(30) Foreign Application Priority Data
Dec. 14, 2019 (DE) 20 2019 106 980.5
Apr. 15, 2020 (DE) 20 2020 102 090.0

(51) Int. Cl. H02G 15/007; H02G 15/02

(52) U.S. Cl. CPC H02G 15/007; H02G 15/02

(57) ABSTRACT

A line guide device comprising a displaceable flexible envelope with duct-like sheaths for lines and end fastening devices in each case comprising two clamping plates with major faces for exerting a clamping force and within each case a retaining portion for strain relief elements. The retaining portion retains the strain relief elements on the respective clamping plate against displacement in the longitudinal direction and, according to the invention, forms a profile cross-section with undercut. The strain relief elements each have at least one connection portion which, for form-fitting engagement behind the undercut, corresponds to the profile cross-section of the retaining portion in order also to retain the strain relief element on the clamping plate in the direction perpendicular to the major face. A variant of the end fastening device comprising two plate connectors for holding the clamping plates together in each case on a lateral end portion, in each case with two opposing clip portions for form-fitting interaction with an end region.

### FIELD

The invention relates in general to line guide devices for lines, such as for example cables, hoses or the like, in particular in clean room applications, namely line guide devices which are displaceable to-and-fro, forming a deflection arc between two runs which originate from a first end and a second end.

The invention relates in particular to improved end fastenings for such dynamic line guide devices.

### BACKGROUND

The line guide devices for clean room applications currently considered generic typically have one or more elongate, flexible envelopes, which generally have duct-like sheaths for lines which extend through in a longitudinal direction and lie next to one another in a transverse direction. Such hose-like envelopes or their sheaths are also known as “pods” and inter alia protect against the exit of abraded particles which arise during displacement of the lines.

For most applications a first end fastening device is provided for the first end and a second end fastening device for the second end of the line guide devices. The end fastening devices serve to connect the ends to one of two connection points, for example a machine, wherein at least one of the connection points is movable relative to the other.

Examples of such line guide devices with end fastening devices specifically suitable therefor are described in DE 10 2012 100 290 B4 or in EP 3 226 252 A1.

An end fastening device is described in utility model DE 20 2019 103 276 U1 or the subsequently published international patent application with application number PCT/IB2020/000047 (cf. FIGS. 13A-13D therein). In this case, the two end fastening devices each have at least two clamping plates with major faces for exerting a clamping force, wherein the clamping plates are each arrangeable with a principal direction perpendicular to the longitudinal direction of the envelope(s) or of the guided lines. Furthermore, two strain relief elements are in each case provided between two clamping plates, with in each case one clamping surface for one or more lines in the dust-tight envelope thereof. The strain relief elements are arranged opposingly between the facing major faces of the clamping plates and retain the envelope together with the line in force-locking manner in the longitudinal direction, in particular for strain relief of the lines with regard to tensile force.

In the end fastening according to DE 20 2019 103 276 U1 or PCT/IB2020/000047, each clamping plate has in each case two retaining portions which each retain a strain relief element on the clamping plate in the direction parallel to the major face, i.e. against displacement in the longitudinal direction of the lines. The retaining portions are in this case provided as elongate through-holes in the clamping plates, which extend in the principal direction of the clamping plates. The strain relief elements project with corresponding projections into these elongate holes and are secured thereby in the longitudinal direction or perpendicular to the principal direction of the clamping plates. Clamping plates with an elongate hole as retaining portion and of comparable function is also described for example in DE 10 2012 100 533 B4 (cf. for example FIGS. 8-9 therein), but therein in contrast for individual strain relief elements which lie side by side.

The clamping plates are typically connected together, for example clamped against one another, using bilateral screw fastenings and also fastened to the connection point, for example of the machine or installation to be supplied.

By means of the strain relief elements, force-locking contact, in particular frictional contact, is exerted on the envelopes and lines guided therein, such that these are fixed to the respective connection point in the longitudinal direction using the end fastening, wherein the lines are strain-relieved.

One disadvantage of the known devices lies in the relatively complex handling of the end fastenings during fitting and removal. The end fastenings have to be regularly removed and refitted for maintenance purposes, in particular if lines have to be exchanged, owing to their service life defined by the movement cycles. When the clamping connection or screw fastenings are undone, known end fastenings come apart, as for instance in DE 10 2012 100 533 B4, into a plurality of individual parts and have accordingly also to be correctly arranged and retained before fastening. This disadvantage is particularly pronounced if the line guide device comprises a plurality of superposed envelope layers or is designed to guide a plurality of lines.

A further disadvantage is that the suitability of known end fastenings for very different line diameters is limited; this applies in particular to the simplified construction according to DE 20 2019 103 276 U1.

Clamping devices for multiple lines with different diameters are known from another field, namely the field of stationary line routing. For example, GB934771A or DE19545867A1 describe devices for fixing several cables next to each other on a stationary surface. Each of these uses two profile rails with U- or C-section as clamping plates, as well as various clamping elements. Each clamping element has a clamping fixture for a cable on one side and a connecting area matching the profile of the profile rail on the other side. However, these clamping devices are costly to manufacture and are not readily suitable for fastening movable cable guides with a sheath.

### SUMMARY

A first object of the invention is therefore to propose a construction for the end fastening which simplifies handling and may nevertheless be better adapted to different line diameters, in particular by being modular. This is achieved by a line guide apparatus or an end fastening device thereof.

A further object is to improve the modular nature of the end fastening, in particular with regard to suitability for the widest range of envelope or line arrangements. This object is achieved according to an independent further aspect of the invention by an end fastening device, which may optionally also simplify handling.

According to a further independent aspect, a modular building kit for end fastening is proposed, which inter alia at least in part overcomes the two above-mentioned disadvantages.

### First Aspect

According to the first aspect, it is proposed according to the invention, for a line guide device or an end fastening device, that the retaining portion of the clamping plate form an undercut profile cross-section, viewed in cross-section perpendicular to the principal direction, i.e. a profile cross-section with at least one undercut. According to the invention, the strain relief elements here in each case have at least one corresponding connection portion, which is configured for form-fitting engagement behind the undercut(s) and accordingly corresponds or interacts with the profile cross-section of the retaining portion.

By engaging behind the connection portions of the strain relief elements in or on the clamping plates, the strain relief element may also be retained reliably on the respective clamping plate in the direction perpendicular to the major face.

This design in particular offers the advantage that prior to fastening or after detaching or removal of a clamping plate, the strain relief elements are retained or remain in a predetermined manner or specified arrangement on the clamping plates, i.e. the end fastening is easier to handle. In particular, it is prevented from falling apart into different individual parts, which for re- or initial fitting would require complex arrangement in the desired manner to match the line arrangement.

This is especially advantageous not only but in particular for applications having a plurality of layers of lines or envelopes and/or having a plurality of different modular strain relief elements, adapted for example in each case to the line diameters.

Furthermore, the back-engaging connection between strain relief elements and clamping plate may also improve force transmission, in particular in the longitudinal direction, or minimize movement play and thereby minimize abrasion in the end fastening itself. Tests have shown that during operation greater particle discharge is typically measurable at the end fastening than at the runs or the deflection arc.

Unlike in DE 20 2019 103 276 U1 or PCT/IB2020/000047, an embodiment is advantageous which has a plurality of individual modular strain relief elements at each clamping plate. With such a further development, the individual strain relief elements are configured for arrangement in opposing rows between mutually facing major faces of the clamping plates, with a plurality of strain relief elements next to each other in each row in the principal direction. For instance, different strain relief elements may in each case be used and prefitted on a clamping plate which match the desired lines in modular manner.

Furthermore, special fastening elements for end-point fixing of the support chain may be used to fasten optionally used additional support chains. Such fastening elements preferably likewise have connection portions which—like those of the strain relief elements—are designed to interact with the profile cross-section of the clamping plates.

A plurality of strain relief elements and fastening elements may thus be attached in a modular manner or alternatively and in each case captively to in each case one clamping plate in order to form a preassembled unit with the clamping plate.

The strain relief elements for lines may be configured at their respective clamping surfaces for example with a type of toothing with protruding tooth portions extending in the longitudinal direction of the lines or in the manner of a comb with individual elongate comb teeth, in order to bring about good frictional engagement for strain relief and at the same time a deformability which makes the strain relief element usable for a range of different line diameters. The strain relief elements may for example also be configured to form a half-shell-shaped sheath with a concavely curved clamping surface, which allows as far as possible matching or mechanically favorable strain relief of the lines in the longitudinal direction optionally together with the corresponding receiving duct of the envelope by force-locking (frictional connection) and optionally clamping connection. The construction of the clamping surface is not critical for the invention, any suitable shape is feasible which retains the corresponding line in the respective envelope in the longitudinal direction at least by force-locking engagement. The clamping surface facing the lines may be provided on a front major side of the strain relief element, this lying opposite a rear major side with the connection portion.

The connection portions of the strain relief elements or optional fastening elements for support chains are configured according to the first aspect for form-fitting engagement in the undercut profile cross-section of the retaining portion of the assigned clamping plate, such that the element is retained on the clamping plate in the longitudinal direction of the lines, i.e. perpendicular to the principal direction of the clamping plate and at the same time in the direction perpendicular to the main plane. The elements are in this case preferably detachably connectable with a clamping plate, in particular transversely of the longitudinal direction of the lines.

The strain relief elements are preferably made in one piece and from plastics material, in particular integrally of a relatively soft plastics material, in particular a thermoplastic, with a strength or a hardness similar to the material of the flexible envelope. The strain relief elements may in this case be made from a suitable plastics material, in particular thermoplastic, with a Shore hardness in the range from 20 Shore A (ShA 20) to 65 Shore D (ShD 65), in particular in the range from 50 Shore A (ShA 50) to 100 Shore A (ShA 100). In this way, damage to the envelope is avoided and abrasion by friction-contact retention on the envelope is minimized. The strain relief elements are in particular preferably made from a softer material and/or with a more readily deformable morphology than the clamping plates, which are intended to transfer a clamping force to the strain relief elements.

The clamping plates are preferably dimensionally stable, in particular flexurally rigid, through suitable dimensioning and/or material selection. The clamping plate has in particular two long end faces and two short narrow sides and may have a substantially rectangular outline.

In a preferred further development, provision is made for the profile cross-section of the clamping plate to open laterally outwards at at least one of the short narrow sides and preferably open laterally outwards at both short narrow sides. The strain relief elements may thus be simply inserted and positioned with the connecting portions into the clamping plate on one or both narrow sides of the clamping plate, in the transverse direction or lateral direction relative to the lines. Also feasible, however, is attachment by turning, for example as in the case of a bayonet coupling or the like.

Particularly preferably, the clamping plate is configured such that the profile cross-section extends over at least a predominant proportion of the length, preferably over the entire length of the clamping plate, such that a plurality of positionings of the strain relief elements are possible.

At least the profile cross-section is preferably embodied uniformly over the entire length of the clamping plate or in the principal direction. The clamping plate may have as a whole over its entire length or in the principal direction a cross-sectionally uniform outer contour. Clamping plates may thus for example be inexpensively produced to size from long profile pieces. In this case, the contour may, in front view or in longitudinal section, in particular be of planar or flat configuration on both major sides.

In a particularly preferred embodiment, the clamping plate, which typically has two long end faces (long sides) parallel to the principal direction, preferably has a profile cross-section formed by an end-face groove on or in each of the two end faces, wherein the groove is preferably mirror-symmetrical to a central plane of symmetry which may lie parallel to the major face. Preferably, corresponding connecting portions engaging both opposing end faces are provided on the strain relief elements. These may then engage in claw- or clip-like manner opposingly in the corresponding end grooves in order to achieve the desired retaining effect.

Through bilateral retention of the elements on the end faces of the clamping plates, a particularly stable hold of the elements on the clamping plates is brought about, i.e. displacements or relative movements between elements and the associated clamping plates, for example through tensile or shearing forces on reciprocal movement of the mobile end fastening, are minimized, such that abrasion and the resultant particles may also be minimized.

In particular but not only in the case of end face retaining portions on the clamping plates, it is advantageous for the strain relief elements in each case to protrude beyond the clamping plate at the end in the longitudinal direction, at least on the free side of the end fastening device remote from the connected run and preferably on both sides. In this way, edge protection may be formed for the lines over the edge of the clamping plates, by which the lines are protected and any abrasion more extensively minimized.

Connection portions are particularly preferred on the strain relief elements which engage on both sides at the end faces of the clamping plate and/or at the same time form an edge protection throughout over the width of the element transversely of the longitudinal direction. By arranging such strain relief elements in a row, edge protection may be produced throughout in the transverse direction in combination with a stable connection between the elements and the clamping plate. Optional fastening elements for support chains or optional spacers may also be configured with corresponding connection portions with edge protection.

In one embodiment provision is made for each clamping plate to have two major faces facing away from one another and for a retaining portion for strain relief elements to be provided on both sides, in each case in or on each of the two major faces. Each retaining portion in this case forms, perpendicular to the principal direction, a profile cross-section with undercut, wherein the two profile cross-sections preferably, taken individually, have identical shaping. For example, strain relief elements and fastening elements may optionally be attached and retained on both sides.

In one embodiment with retaining portions on both sides, provision is made for the two retaining portions to be provided on the clamping plate offset relative to one another in the longitudinal direction or in a direction perpendicular to the principal direction. In this case, the retaining portions may preferably be arranged rotationally symmetrically to a main central axis of the clamping plate, such that matchingly configured strain relief elements are equally usable on both sides of the clamping plate simply by being turned around. The retaining portions or profile cross-sections are preferably arranged centrally in one of two width halves of the clamping plate, wherein the two width halves of the clamping plate may in particular be configured rotationally symmetrically relative to one another. “Width half” here means a half after lengthwise bisection.

In one preferred embodiment, the or each retaining portion may be mirror-symmetrical in configuration, in particular to a central plane of symmetry perpendicular to the major face, i.e. in particular with two mirror-symmetrical undercuts. This in particular further simplifies handling in the case of centrally arranged retaining portions.

Alternatively or optionally also in addition, provision may be made for each retaining portion to comprise a profile groove recessed relative to the major face and/or a profile projection protruding relative to the major face. This may for example be configured centrally in the major face or centrally in a width half, e.g. as a through-profile groove in the principal direction.

In principle, profile cross-section is in the present case understood to mean a cross-section with any type of profile which according to the invention allows back engagement by a strain relief element, in order to retain the latter in the direction perpendicular to the major face of the clamping plate. The profile may in this case form a positive shape, in particular a projection, and/or a negative shape (space), in particular a profile groove. The profile cross-section may be molded together with the clamping plate on production of the latter, for example using continuous casting or injection molding, or be incorporated subsequently by machining, for example by milling.

The profile groove and/or the profile projection may exhibit any suitable shaping with undercut(s), for example a T-shaped, V-shaped or dovetail-shaped or similar back-engageable profile cross-section.

The connection portions of the strain relief elements have a cross-section correspondingly conjugate to the profile cross-section, in particular a form-fittingly matching cross-section, and should be displaceable in the principal direction, i.e. transversely of the longitudinal direction of the lines, on the retaining portion due to slight play, in order further to simplify handling on fitting or subsequent adaptation of the line guide.

Features of the above-stated first aspect of the invention may advantageously be combined with those of the following second aspect and vice versa.

### Second Aspect

According to an independent second aspect, an end fastening device is proposed for fastening an end of a generic line guide device. The end fastening device comprises at least two clamping plates with major faces for exerting a clamping force, wherein the clamping plates in each case have two lateral end portions and two long end faces, which extend parallel to a principal direction. The clamping plates are arranged as intended with the long end faces perpendicular to the envelope or the lines. In addition, the end fastening device has a number of, but at least two strain relief elements, each with a clamping surface for in each case one or more lines, wherein the strain relief elements are intended for opposing arrangement between facing major faces of the clamping plates.

According to the independent second aspect, it is proposed according to the invention to provide two separate plate connectors, which serve to retain two associated clamping plates at in each case one of the two lateral end portions, wherein each plate connector has two opposing, in particular vertically opposing clip portions, which in each case interact with an end portion of one of the two clamping plates. According to the invention, the plate connectors are configured to hold the at least two clamping plates together, in particular in the vertical direction or perpendicular to the plate direction by in each case end-face gripping of the clamping plates.

The two plate connectors may hold the clamping plates in particular at a predetermined distance from one another and/or parallel to one another.

Two clamping plates may in each case be held in pairs against one another at their lateral end portions, which lie at the two short (narrow) sides, by such a separate, interposed plate connector and connected together in pairs. Each of the opposing clip portions preferably engages at least form-fittingly with each clamping plate.

Use of the plate connectors in particular simplifies handling in the case of a multilayer arrangement with a plurality of envelopes one above the other, since a respective layer is already retained when the plate connectors are attached to the corresponding clamping plates for this layer. The plate connectors may serve in prefixing and in this case achieve a clamping force on the lines in the envelope in conjunction with suitable strain relief elements. A separate screw fastening does not have to be produced for this purpose. Conversely, opening or access to an individual layer, for example for targeted replacement of a line may also be simplified, since in the case of a multilayer structure adjacent layers do not have to be removed.

Furthermore, separate plate connectors enable simplification of the clamping plate structure. These may for example optionally be cut to size from a longer profile to match the desired width of the end fastening.

A plate connector according to the second aspect may thus, with its clip portions, connect and retain two clamping plates in pairs in the longitudinal direction and perpendicular to the major face.

The plate connectors are preferably connected detachably with the end portions of the clamping plates, in particular displaceably laterally or in the transverse direction relative to the clamping plates, so enabling lateral detachment.

The plate connectors may in particular connect the two clamping plates together in the manner of a clip and hold them, in the direction perpendicular to the major face, at a specified spacing determined by the plate connectors. One advantage is that a screw fastening is not absolutely necessary for producing the desired strain relief, and the desired force-locking engagement with the envelope or the lines may be achieved by suitable selection of strain relief elements and/or plate connectors.

Alternatively or in addition, the clip portions of the plate connectors are particularly preferably—in a manner similar to the connection portions of the clamping elements—embodied for interaction with a profile cross-section of the clamping plate which preferably opens outwards at both short narrow sides. In this way, the plate connectors may be laterally readily attached and detached again.

Furthermore, each plate connector may comprise a supporting body, which represents a spacer for predetermining the vertical distance between the clamping plates. The supporting body preferably has a structural height which amounts to at least twice the structural height of a strain relief element, for example of a specific associated strain relief element from a kit.

At least one vertical through-hole for a screw fastening is preferably provided in the supporting body, said screw fastening serving in fastening, in particular to a connection point.

For both aspects, i.e. notwithstanding the first or second aspect, the following further features are in each case advantageous.

In one embodiment, each strain relief element is configured such that it projects in the longitudinal direction beyond the end faces of the clamping plates and forms a sheath at a rear side remote from the clamping surface, in which sheath the respective clamping plate may be at least partly accommodated.

In particular in combination with the latter construction and/or the second aspect, it is advantageous for each strain relief element to have opposing connection portions for form-fitting engagement in a corresponding undercut of a profile groove or molded groove at the end face of the clamping plate, in order to retain the respective strain relief element on the respective clamping plate in the direction perpendicular to the major face of this clamping plate. In this case, the structural height of the connection portions may per se preferably be less than or equal to half the plate thickness of a clamping plate, such that strain relief elements are fastenable unimpeded on both sides on the same clamping plate.

The connection portions of the elements, in particular strain relief elements, if these are attached to a major side of the clamping plate, preferably do not project beyond the opposing major side.

In principle, precisely one strain relief element could be provided on each major side of the clamping plate. A modular construction is preferred, however, in which in each case a plurality of strain relief elements, in particular elements selected to match the application from a kit of different strain relief elements and optionally fastening elements for support chains, are arranged in a row in the principal direction on the clamping plate

The elements are preferably in each case retained displaceably in the principal direction for positioning on a clamping plate and/or detachably on a clamping plate.

Particularly inexpensive production is enabled if the clamping plates are embodied as substantially flat plates, in particular with major faces which are planar in longitudinal section or with a plate thickness which is uniform in the principal direction.

In this case, the clamping plates may be produced from a continuous profile, for example from an extruded metal profile, in particular of aluminum, in particular with a profile cross-section according to the first aspect, by cutting to the desired lengths. Alternatively, the clamping plates may for example also be made from reinforced plastics material, for example by injection molding.

The strain relief elements and optionally fastening elements are on the other hand preferably made in one piece of plastics material, in particular as injection moldings.

The plate connectors are preferably made in one piece from a harder plastics material than the strain relief elements, in particular as injection moldings, for example from a fiber-reinforced polymer. The plate connectors are dimensionally stable in particular perpendicular to the major face of the clamping plates, i.e. under intended load they are not extendable or compressible, in order to allow force-locking engagement between strain relief elements and lines in interaction with the clamping plates. The desired force for retaining the line(s) may be achieved by suitable selection or dimensioning of the plate connectors in combination with suitable selection or dimensioning of the strain relief elements. A screw fastening is not necessary for this purpose.

The strain relief elements may have an active side, on which the clamping surface is provided, which is for example. concave or alternately concavely/convexly curved or indeed concavely/convexly shaped with toothing or in the manner of a comb, when viewed in cross-section along the principal direction or perpendicular to the longitudinal direction of the line(s). The clamping surface may in this case be cylindrical in the general geometric sense, i.e. with a uniform section parallel to the principal direction.

Differently adapted strain relief elements may be provided in particular for different line diameters, said elements being connectable in modular manner with a clamping plate.

In particular in the case of multilayer applications with a plurality of envelopes one above the other, it is mechanically favorable for the clamping plates to have in each case at least two through-holes for screw fastenings in both lateral end portions and to have one or more additional through-holes for screw fastenings between the end portions along the principal direction. Such a through-hole may optionally also take the form of an elongate hole, and serve for the attachment of additional screws for fastening and/or clamping action.

The plate connectors may have at least two, preferably three through-holes for screw fastenings, which are preferably arranged for aligned arrangement with corresponding through-holes for screw fastenings in the clamping plates.

A further advantage of the two aspects, in particular of the second aspect, consists in that optionally just three clamping plates arranged one above the other suffice for fastening of at least two envelopes in superposed layers, wherein on the middle clamping plate in the mounted state of the end fastening strain relief elements are retained on both sides, namely for fixing not only the one envelope on the one side of the middle clamping plate but also the other envelope on the other side. It is thus not necessary in each case to provide two clamping plates for each layer or envelope. In this way, material costs are reduced and handling is further simplified.

### Third Aspect

According to a third independent aspect, the invention finally also relates to a modular building kit for generic end fastenings. According to the third aspect, the building kit is characterized, in its minimal embodiment, by at least five different components, namely:
at least one flat clamping plate; —at least two different types of strain relief element with in each case different structural heights and in each case connection portions of identical construction for securing to the clamping plate at least in a longitudinal direction; —at least two different types of plate connector with different structural heights, wherein each plate connector has two opposing clip portions of identical construction, which in each case interact at least form-fittingly with the clamping plate, in particular with an end portion of the clamping plate.

All the above-described features of the individual components, in particular of the clamping plates, strain relief elements and plate connectors are also advantageously applicable in the building kit.

The use of two plate connectors of different structural heights in particular allows modular use of the end fastening with just one design of clamping plate both for a multilayer arrangement with two or more superposed envelopes. which are retained optionally nested between just two clamping plates, and also for single-layer arrangements. Such a building kit may be better adapted, with just a minimum number of parts, to the various applications, in particular line diameters, and yet still simplifies handling during production and onsite maintenance. However, a number with more than two different types of strain relief element is preferably provided for different line diameters.

Particularly preferably, clamping plate and strain relief elements in the building kit are configured according to the first aspect, wherein the clamping plate in each case has at least one retaining portion with a profile cross-section with undercut and each strain relief element in each case has a connection portion in order to retain the strain relief element on the clamping plate by engaging behind the undercut of the profile cross-section in the direction perpendicular to the major face of said clamping plate.

In a preferred embodiment of all aspects, the strain relief elements project in the longitudinal direction or perpendicular to the principal direction of the clamping plates beyond the end faces thereof, in particular on both sides and/or grip at least in part around the respective end face to form an edge protection.

### BRIEF DESCRIPTION OF THE DRAWINGS

Further details and advantages of the invention may be inferred, without restricting the general nature of the above, from the following explanation of preferred exemplary embodiments on the basis of the appended drawings. Features of corresponding or identical structure or function have corresponding reference signs and may not be repeatedly described.

In the figures:

FIGS. 1A-1B are schematic representations of a generic line guide apparatus in perspective view (FIG. 1A) and in cross-section transversely of the longitudinal direction (FIG. 1B) according to the prior art for example from DE 20 2019 103 276 U1;

FIGS. 2A-2C shows a first exemplary embodiment of an end fastening for a line guide apparatus according to FIGS. 1A-1B assembled in perspective view (FIG. 2A) and in exploded view (FIG. 2B) and inside view (FIG. 2C);

FIG. 2D shows a variant of an end fastening according to FIGS. 2A-2B in perspective view with other strain relief elements;

FIGS. 3A-3B are a cross-sectional view and a side view of a second exemplary embodiment of an end fastening device;

FIGS. 4A-4B are a cross-sectional view and a side view of a third exemplary embodiment of an end fastening device;

FIGS. 5A-5C show a fourth exemplary embodiment of an end fastening device in cross-section (FIG. 5A) and in partial perspective view (FIGS. 5B-5C);

FIGS. 6A-6C show a fourth exemplary embodiment of an end fastening device in cross-section (FIG. 6A) and in partial perspective view (FIGS. 6B-6C);

FIGS. 7A-7B show a front view and a plan view of a further exemplary embodiment of an end fastening device different from FIGS. 6A-6C; and

FIGS. 8A-8C show plan views onto different variants of clamping plates, in particular for an exemplary embodiment according to FIGS. 2A-2D.

### DETAILED DESCRIPTION

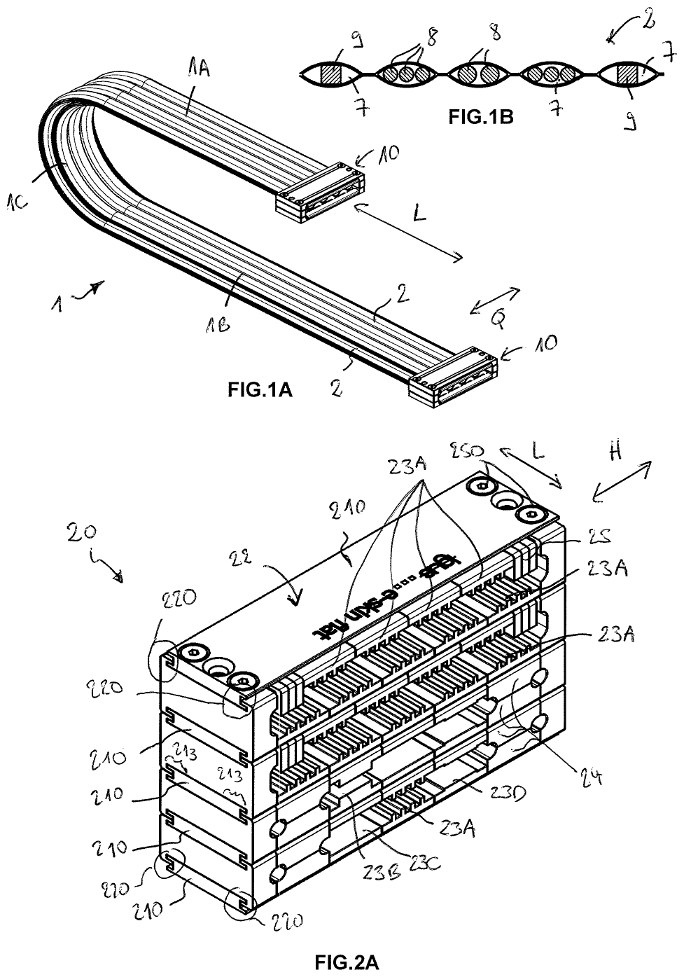

FIGS. 1A-1B show an exemplary embodiment of a dynamic line guide apparatus 1, i.e. one which is displaceable to-and-fro, for supply lines 8, for example for power and data supply in a machine. The line guide apparatus 1 is linearly displaceable and in the process forms a mobile upper run 1A, a stationary lower run 1B and therebetween a co-traveling deflection arc 1C. The upper run 1A is displaceable in the longitudinal direction L of the line guide apparatus 1. The deflection arc 1C has a predetermined deflection radius or bending radius about a transverse direction Q, perpendicular to longitudinal direction L. In FIG. 1A the line guide apparatus 1 comprises two flexible envelopes 2 elongated in the longitudinal direction L and nested one above the other. The spatial position is arbitrary, however, and the line guide apparatus 1 may for example also move vertically. Each envelope 2 is hose-like overall and sufficiently flexibly embodied, inter alia through suitable design and/or material selection, to allow reversibly flexible curvature of the deflection arc 1C with little expenditure of effort and to follow the travel motion of a mobile connection or moving end with the least possible resistance.

Each dust-protecting envelope 2 (also known as a “pod”) is in particular of dust-tight embodiment and serves primarily to prevent exit to the outside of particles which inevitably arise in particular through abrasion of the lines and/or support chain. The construction of the hose-like envelope 2 may for example be selected to be as described in DE 20 2019 103 276 U1, FIGS. 9-10, the teaching of which is hereby included for brevity's sake. Other hose-like envelopes 2, for example from the prior art mentioned above, may be used.

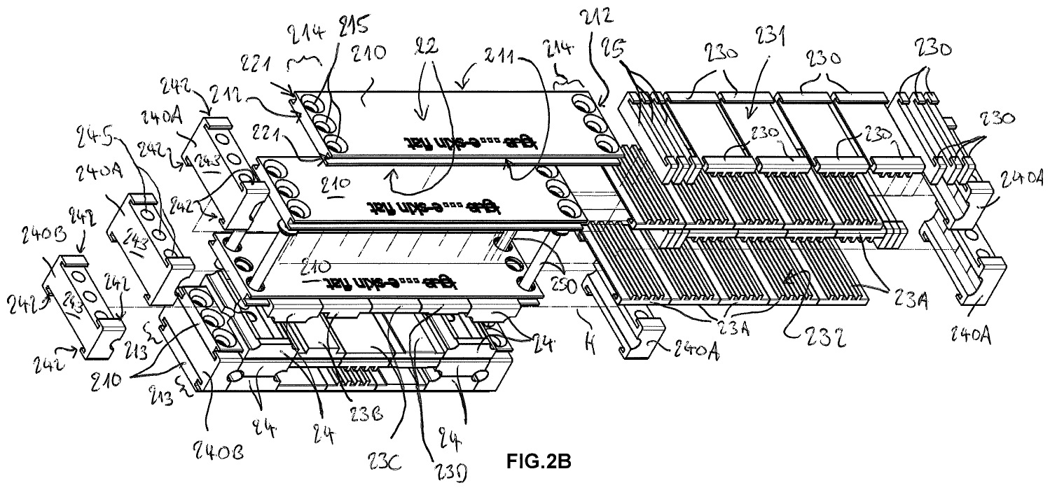

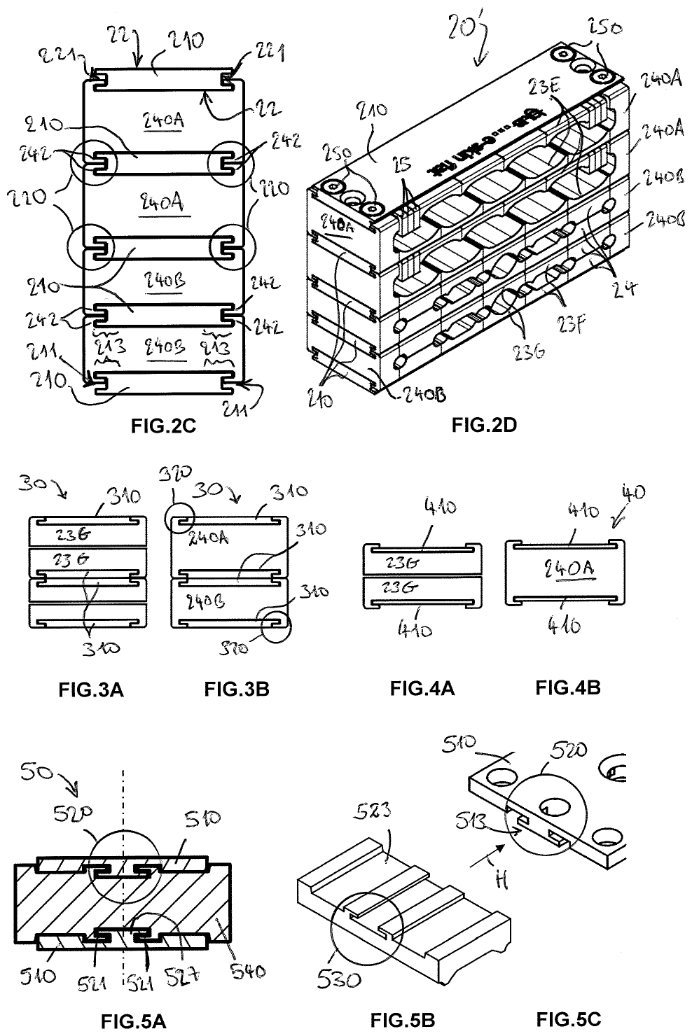

FIG. 1A further shows two end fastening devices 10, which are each provided at one end of the line guide apparatus 1. The line guide apparatus 1 is connected and fastened, using the end fastening devices 10, in each case to one of two connection points mobile relative to one another, for example on a machine or installation (not shown). FIG. 1A shows end fastening devices according to DE 20 2019 103 276 U1 (cf. FIGS. 13A-13D therein). Preferred embodiments according to the invention of the end fastening devices, instead of those from FIG. 1A, are explained further below in relation to FIGS. 2-8.

FIG. 1B shows merely by way of example a possible internal subdivision of one of the two envelopes 2 in a cross-section perpendicular to longitudinal direction L. The envelope 2 may for example be composed of a plurality of individual envelope units (not shown) made from plastics material or from a one-piece hose with a plurality of ducts as sheaths 7. In FIG. 1B the envelope 2 has by way of example five duct-like sheaths 7 for one or more supply lines 8 or bundles of lines and two support chains 9 in the outer sheaths, which predetermine the radius of the deflection arc 1C and support a self-supporting length of the advanced upper run 1A. The envelope 2 is made from a flexible, pliable plastics material, in particular a thermoplastic, for example PE, PU, TPU, PTFE, expanded PTFE, PP or the like, and has a cross-section perpendicular to longitudinal direction L which is constant throughout over the length thereof. The envelope 2 may be produced inexpensively as a strand product using suitable plastics extrusion technology and cut to a suitable length, for example of around 100 mm to around 1500 mm. All the sheaths 7 within the envelope 2 are spatially separate from one another and lie next to one another in transverse direction Q. The envelope 2 surrounds the lines 8 or support chains 9 over the longitudinal extent in dust-tight manner and thus prevents the escape of particles, which arise for example. through abrasion or wear.

FIGS. 2A-2B show a particularly preferred example of an end fastening device 20 according to the invention. The end fastening device 20 is usable at both ends of the line guide apparatus 1. It has a number of clamping plates 210 of identical construction, which are produced in FIGS. 2A-2D as substantially flat rectangular plates of metal, for example of an extruded aluminum profile. The clamping plates 210 form a major face 22 on each major side for exerting a clamping force and are arranged with their principal direction H, which corresponds to the longitudinal extent of the clamping plate 210, perpendicular to the longitudinal direction L of the envelope 2 (cf. FIG. 1A). All the clamping plates 210 are of like construction and have two long end faces 211 in the principal direction H, transversely of which the lines 8 are conducted, and two short narrow sides 212.

The end fastening device 20 in FIGS. 2A-2D is of multilayer construction, for a plurality of envelopes 2 one on top of the other, and comprises in each layer a number of modular strain relief elements 23A, 23B, 23C, 23D etc. of different designs. In each of the exemplary four layers shown here, identical strain relief elements 23A, 23B, 23C and 23D are respectively located opposite one another in pairs between two clamping plates 210. The strain relief elements 23A, 23B, 23C, 23D in each case have a clamping surface 232 for force-locking retention of one or more lines 8 (cf. FIG. 1B) in the respective duct-like sheath 7 together with the envelope 2. The strain relief elements 23A, 23B, 23C, 23D are modular and are configured for strung-together, opposing arrangement between facing major faces 22 of the clamping plates 210.

As is most clearly apparent from the side view FIG. 2C, each of the clamping plates 210 of identical construction in each case has a retaining portion 213, inter alia for strain relief elements 23A, 23B, 23C, 23D etc., which retains these on the respective clamping plate 210 against displacement in the longitudinal direction L. As is most clearly apparent from FIGS. 2B-2C, the clamping plates 210 to this end each have on their long end faces 211 pronounced retaining portions 213 facing away from one another and with a profile cross-section 220 here at the end with in each case one undercut when viewed in cross-section or side view, wherein the undercut in FIGS. 2A-2D is embodied at the end faces 211 by a groove 221 or recess which is roughly U-shaped or constant throughout in the principal direction. The groove 221 is here in each case mirror-symmetrical and perpendicular to both central planes and parallel to the main faces 22 and has a rounded rectangular cross-section, with approximately half the structural height of the clamping plate 210.

The various strain relief elements 23A, 23B, 23C, 23D etc. in each case have two connection portions 230, here with claw-shaped cross-sections relative to the principal direction H, configured for form-fitting engagement behind the undercut or groove 221 in the profile cross-section 220 of the retaining portion 213 of the clamping plate 210, i.e. for engagement in the end-face groove 221 as apparent from FIGS. 2A-2D. The connection portions 230 are in each case embodied at the two end faces as mirror-symmetrical claws of identical construction, wherein each claw of a connection portion 230 occupies not quite half of the free height of the end-face groove 221, such that in each case strain relief elements 23A, 23B, 23C, 23D with corresponding connection portions 230 may engage in the profile cross-section 220 of the retaining portion 213 on both sides on each clamping plate 210, cf. FIG. 2C.

Between the opposing connection portions 230 a sheath 231 is formed on the rear side of the strain relief elements 23A, 23B, 23C, 23D, which sheath accommodates approximately half of the cross-section of the respectively associated clamping plate 210. For instance, one and the same clamping plate 210 may be used for two successive layers of envelopes 2, as the three vertically interior clamping plates 210 in FIG. 2A illustrate. The strain relief elements 23A, 23B, 23C, 23D have different clamping surfaces and a substantially identical base area for modular use. The strain relief elements 23A, 23B, 23C, 23D may be made from the same pliable, low-abrasion plastics material as the envelopes 2 (see above).

Through the design of the connection portions 230 which engage form-fittingly in the undercut(s) of the clamping plates 210, the strain relief elements 23A, 23B, 23C, 23D are retained captively on the respective clamping plate 210 not only in the longitudinal direction L, but also in the direction perpendicular to the major face 22.

FIGS. 2A-2D furthermore show special fastening elements 24 for support chains 9, which secure the support chains 9 to the end fastening device 20 in the longitudinal direction L. The fastening elements 24 have connection portions 230 and sheaths 231 of identical construction on their rear sides (not shown). The same is also true of additional spacers 25 in the top two layers of FIGS. 2A-2D. These spacers 25 allow lateral offset in the transverse direction Q between the opposing strain relief elements 23A, such that in each case two envelopes, as shown in FIG. 1A, lying one above the other may be jointly secured between two clamping plates 210 in the top two layers. The spacers 25 have, like the fastening elements 24, claws for retention on the clamping plates 210 which are likewise cross-sectionally identical to the connection portions 230. The fastening elements 24 and spacers 25 are thus likewise securely retained and fixable on the clamping plates 210 in the longitudinal direction L and perpendicular to the major faces 22.

As FIGS. 2A-2D further show, the profile cross-section 220 opens on both sides at the short narrow sides 212 to the outside, i.e. is laterally openly accessible. The profile cross-section 220 is constant throughout over the entire length in the principal direction H or between the narrow sides 212. In this way, strain relief elements 23A, 23B, 23C, 23D, fastening elements 24 and spacers 25 may optionally be attached in modular manner or as required on the clamping plates and positioned at any position through insertion along the principal direction H.

FIG. 2B additionally illustrates by way of example toothed clamping surfaces 232 for force-locking retention of the lines 8 with the envelope 2 on the strain relief elements 23A (in the upper layers). In this case, the clamping surfaces 232 have tooth strips or comb teeth projecting alternately between recesses and extending in the longitudinal direction L, which tooth strips or comb teeth achieve a degree of deformability for adaptation to different diameters of the lines 8 and at the same time achieve good frictional engagement. By way of example, only the clamping surface 232 is briefly described. Flat designs are also possible, as for instance in the case of strain relief elements 23B, 23C, 23D which differ primarily by different structural heights or depths of the respective clamping surfaces. Furthermore, strain relief elements 23E, 23F, 23G with concave or concave/convex clamping surfaces can also be used, as in the variant of FIG. 2D. These strain relief elements 23E, 23F, 23G also have connection portions 230 which interact with the retaining portions 213. The end fastening device 20′ in the variant of FIG. 2D differs substantially through these differently shaped strain relief elements 23E, 23F, 23G.

As FIGS. 2A-2D further show, the end fastening device 20 according to a further aspect has in each case between lateral end portions 214 of the clamping plates 210 two plate connectors 240A, 240B provided as separate components, in order to grip and connect in each case two clamping plates 210 in pairs on in each case one of the two lateral end portions 214. To this end, each plate connector 240A, 240B has two opposing clip portions 242, which according to FIGS. 2A-2D correspond in construction to the claw-like connection portions 230 of the strain relief elements 23A-23G, i.e. have two mutually facing end-face claws. The plate connectors 240A, 240B have however in each case at their top and bottom a corresponding clip portion 242 for connection with two clamping plates 210. Using the plate connectors 240A, 240B, the clamping plates 210 are in each case connected together in pairs and retained parallel at a predetermined distance from one another. To this end, the opposing clip portions 242 grip in each case in pairs at least form-fittingly in the end-face groove 221 of the clamping plates 210, in a manner similar to the connection portions 230 (cf. FIG. 2C). In the example of FIGS. 2A-2D two types of plate connector 240A, 240B are shown, which differ merely in different structural heights, such that through selection of the plate connectors 240A, 240B the space between the strain relief elements 23A-23G opposing one another in pairs may be adjusted. Structurally identical plate connectors 240A or 240B are inserted between two clamping plates 210 in each case at the two end portions 214. These are likewise laterally insertable in the principal direction H and re-detachable. The plate connectors 240A, 240B have a block-like supporting body 243, here of solid material, in particular a dimensionally stable, non-resilient plastics material such as for example a fiber-reinforced polyamide. The supporting body 243 has a vertical spacer for predetermining the vertical distance between the clamping plates 210. The plate connectors 240A, 240B differ in particular in the structural height of the supporting body 243 and are otherwise of identical construction, in particular their vertically and horizontally mirror-symmetrical clip portions 242. The plate connectors 240A, 240B may unilaterally have a concave opening to the accommodation space for the envelopes.

The plate connectors 240A, 240B in each case have, identically arranged in their supporting bodies 243, three through-holes 245 distributed in the longitudinal direction L for screw fastenings using screws 250. The through-holes 245 are arranged to match the aligned arrangement with corresponding through-holes 215 for the screws 250 in the clamping plates 210. The outer two screws 250 in the end portions 214 may be used for lateral securing of the ready-mounted end fastening device 20, 20′, as may be seen in FIGS. 2A/2D. To this end, in the bottom clamping plate 210 a threaded bush may in each case be driven into the corresponding through-holes 215 at the bottom, or a nut can be used. The middle through-holes 215, 245 may be used to fasten the end fastening device 20, 20′ to the connection point, i.e. to the fixed point or moving end (not shown).

As is further apparent from FIGS. 2A-2D, the connection portions 230 of the strain relief elements 23A-23G and also of the fastening elements 24 and spacers 25 serve at the same time as edge protection at the end faces 211 of the clamping plates 210, such that the lines 8 cannot come into contact with the end faces 211 of the clamping plates 210.

FIGS. 3A-3B show a modification with an end fastening device 30, here by way of example for two layers of envelopes, which differs merely in the design of the clamping plates 310. These likewise have a profile cross-section 320 with an undercut, which is not however symmetrical to the central plane of the clamping plate 310. The clamping plate 310 corresponds in construction to a vertically bisected clamping plate 210 of FIGS. 2A-2D, such that two clamping plates 310 have to be provided arranged inverted one on top of the other between two successive layers. This allows less costly production of the clamping plate 310 with lower material cost.

A further simplification of the clamping plate 410 is shown in the variant of the end fastening device 40 of FIGS. 4A-4B, with a substantially flat plate without undercut being used here, which is particularly inexpensive to produce. The example according to FIGS. 4A-4B further illustrates that the second aspect of the invention relating to the construction with separate plate connectors 240A, 240B may also optionally be used independently of the first aspect, i.e. the connection between strain relief elements 23A-23G and the clamping plates 410. In FIGS. 4A-4B in each case two clamping plates have to be used for each layer.

FIGS. 5A-5C show an exemplary embodiment of an end fastening device 50 with an alternative design of profile cross-section 520 for the clamping plate 510. The profile cross-section 520 is here provided as a combination of a cross-sectionally T-shaped projection 527 with two mirror-symmetrical L-shaped grooves 521 as undercuts in the plate body of the clamping plate 510. The profile cross-section 520 is provided on just one of the two major sides of the clamping plate 510 and is mirror-symmetrical relative to the vertical longitudinal central plane of the clamping plate 510 (FIG. 5A). In the case of clamping plate 510 too, the profile cross-section 520 is identical throughout in the principal direction H and laterally open on both sides for insertion of the strain relief elements 523 or plate connectors 540 etc. in the principal direction H. The strain relief elements 523 or plate connectors 540 have a connection portion 530, with matching cross-sectional profile, shaped accordingly as a form-fitting counterpart.

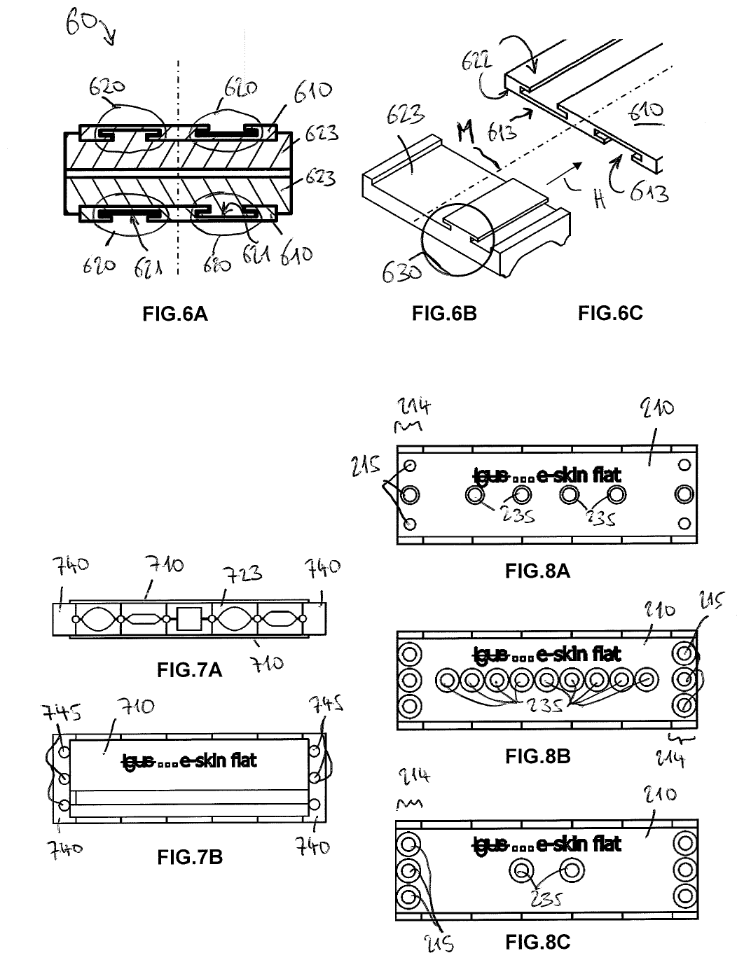

FIGS. 6A-6C show a further exemplary embodiment of an end fastening device 60 with an alternative design of the profile cross-section 620 of the clamping plate 610, here with two retaining portions 613 on each clamping plate 610. The clamping plate has in each case one retaining portion 613 for strain relief elements 623 at both major faces 622. Perpendicular to the principal direction H, the retaining portions 613 here also form a profile cross-section 620 with a double undercut, for example formed in each case of a T-shaped groove 621, which is fully let into the plate body of the clamping plate 610.

The two retaining portions 613 are provided on the clamping plate 610 in each case on one of the two major faces 622 facing away from one another, said retaining portions being offset relative to one another in the longitudinal direction L, i.e. perpendicular to the principal direction H, and arranged rotationally symmetrically to a main central axis M. The retaining portions 613 are furthermore arranged centrally in one of two width halves of the clamping plate 610. Thus, with the construction of the clamping plate 610, strain relief elements 623 and plate connectors (not shown) can also engage with correspondingly matchingly shaped connection portions on both sides of the clamping plate. Other features in FIGS. 5A-5C and FIGS. 6A-6B correspond to those described above in relation to FIGS. 2A-2D.

A further variant of an end fastening device 70 is shown in FIGS. 7A-7B, in which the clamping plate 710 may for example have the cross-section of the clamping plate 610 from FIGS. 6A-6C. FIGS. 7A-7B show that lateral securing with screws is also possible without corresponding through-holes in the clamping plates 710, through the laterally protruding arrangement of the plate connectors 740, which have through-holes 745 as described in relation to FIG. 2C.

FIGS. 8A-8C show variants of the clamping plates 210 from FIGS. 2A-2D. Between the lateral end portions 214 additional through-holes 235 for screw fastenings are provided according to different drill patterns for an optionally improved clamping action, for example in the case of multilayer end fastenings.

### LIST OF REFERENCE SIGNS

### FIGS. 1A-1B:

1 Line guide apparatus
1A Upper run, 1B Lower run, 1C Deflection arc
2 Envelope
7 Sheath
8 Supply line
9 Support chain
10 End fastening device
L Longitudinal direction
Q Transverse direction

### FIGS. 2A-2D:

20, 20′ End fastening device
24 Fastening elements
25 Spacer
210 Clamping plates
211 End face (long side)
212 Narrow face (short side)
213 Retaining portion
214 End portion
22 Major face
23A, 23B, 23C, 23D, 23E, 23F, 23G Strain relief elements
230 Connection portion (with claws)
231 Sheath
232 Clamping surface
240A, 240B Plate connectors
242 Clip portions
243 Supporting body
215, 245 Through-holes (for screws)
250 Fastening screws
L Longitudinal direction
H Principal direction (corresponds to transverse direction Q)

### FIGS. 3A-3B; FIGS. 4A-4B

30; 40 End fastening device
310; 410 Clamping plates
320 Profile cross-section
240A, 240B Plate connectors

### FIGS. 5A-5B; FIGS. 6A-6B

50; 60 End fastening device
510; 610 Clamping plate
513; 613 Retaining portion
520; 620 Profile cross-section
521; 621 Groove
622 Major face
523; 623 Strain relief element
527 Projection
530; 630 Connection portion
540 Plate connector
H Principal direction
M Main central axis

### FIGS. 7A-7B

710 Clamping plate; 740 Plate connector; 745 Through-holes

### FIGS. 8A-8C

210 Clamping plate; 214 End portions; 215, 235 Through-holes

What is claimed is:

1-22. (canceled)

23. An end fastening device for fastening an end of a line guide device which is displaceable to-and-fro and has at least one elongate, flexible envelope, which comprises a number of duct-like sheaths for lines, the sheaths extending in a longitudinal direction from a first end to a second end, comprising:
at least two clamping plates with substantially flat major faces for exerting a clamping force, wherein the clamping plates are each arrangeable with a principal direction perpendicular to the longitudinal direction of the envelope; and
a number of strain relief elements, each with a clamping surface for one or more lines and for opposing arrangement between facing major faces of the clamping plates;
wherein the at least two clamping plates each have a retaining portion for strain relief elements, which retains the strain relief elements on the clamping plate in a direction parallel to the major face against displacement in the longitudinal direction, wherein each of the at least two clamping plates has two long end faces parallel to the principal direction, wherein
the retaining portion forms a profile cross-section with undercut, and wherein
the strain relief elements each have at least one connection portion which, for form-fitting engagement behind the undercut, corresponds to the profile cross-section of the retaining portion in order also to retain the strain relief element on the respective clamping plate in the direction perpendicular to the major face, wherein the profile cross-section is formed by an end-face groove on each of the two end faces, and corresponding end-face connection portions are provided on the strain relief elements.

24. The end fastening device as claimed in claim 23, wherein the clamping plate has two long end faces and two short narrow sides, wherein the profile cross-section opens outwards at at least one of the short narrow sides and preferably opens outwards at both short narrow sides, and/or in that the profile cross-section extends over at least a predominant proportion of the length, preferably over the entire length of the clamping plate.

25. The end fastening device as claimed in claim 23, wherein the connection portions form an edge protection protruding at the end face for the lines.

26. The end fastening device as claimed in claim 23, wherein each clamping plate has two major faces facing away from one another and in each case a retaining portion for strain relief elements is provided on both sides which forms, perpendicular to the principal direction, a profile cross-section with an undercut.

27. The end fastening device as claimed in claim 26, wherein the two retaining portions are provided on the clamping plate offset relative to one another in the longitudinal direction, and are preferably arranged rotationally symmetrically to a main central axis, and/or are preferably arranged centrally in one of two width halves of the clamping plate.

28. The end fastening device as claimed in claim 23, wherein the retaining portion is mirror-symmetrical in configuration, in particular with two mirror-symmetrical undercuts.

29. The end fastening device as claimed in claim 23, wherein each retaining portion comprises a profile groove recessed relative to the major face and/or a profile projection protruding relative to the major face.

30. The end fastening device as claimed in claim 29, wherein the profile groove and/or the profile projection forms a T-shaped, V-shaped or dovetail-shaped profile cross-section and the connection portions of the strain relief elements have a form-fittingly matching cross-section.

31. An end fastening device for fastening an end of a line guide device which is displaceable to-and-fro and has at least one elongate, flexible envelope, which has a number of duct-like sheaths for lines extending in a longitudinal direction from a first end to a second end, comprising:
at least two clamping plates with substantially flat major faces for exerting a clamping force, wherein the clamping plates in each case have two lateral end portions and two long end faces, which extend parallel to a principal direction, and are arrangeable with the end faces perpendicular to the envelope; and
a number of strain relief elements, each with a clamping surface for one or more lines and for opposing arrangement between facing major faces of the clamping plates; wherein
two separate plate connectors are provided, in order to retain the at least two clamping plates at in each case one of the two lateral end portions, wherein each plate connector has two opposing clip portions, which in each case interact at least form-fittingly with an end portion, and the plate connectors are configured to hold the at least two clamping plates together.

32. The end fastening device as claimed in claim 31, wherein, with their clip portions, the plate connectors hold two clamping plates together in the longitudinal direction and perpendicular to the major face, wherein in particular the clip portions interact with an undercut profile cross-section of the clamping plate and/or the clip portions are preferably configured to grip around the two end faces of the clamping plate in the end portion thereof, preferably with two longitudinally opposing claws.

33. The end fastening device as claimed in claim 31, wherein each plate connector comprises a supporting body, which represents a spacer for predetermining the vertical distance between the clamping plates.

34. The end fastening device as claimed in 31, wherein each strain relief element projects in the longitudinal direction beyond the end faces of the clamping plates and forms a sheath at a rear side remote from the clamping surface, in which sheath the respective clamping plate may be at least partly accommodated.

35. The end fastening device as claimed in claim 23, wherein a plurality of strain relief elements are arranged in a row in the principal direction and/or are retained displaceably on a clamping plate and/or are retained detachably on a clamping plate.

36. The end fastening device as claimed in claim 31, wherein the clamping plates are embodied as flat plates with major faces which are planar in front view or with a plate thickness which is uniform in the principal direction.

37. The end fastening device as claimed in claim 23, wherein the clamping plates are made of metal, preferably extruded metal profiles, in particular of aluminum, or of reinforced plastics material, in particular as injection moldings.

38. The end fastening device as claimed in claim 23, wherein:
the strain relief elements are made in one piece of plastics material, in particular as injection moldings, wherein the plate connectors are preferably made in one piece from a harder plastics material than the strain relief elements, in particular as injection moldings; and/or
the strain relief elements are made from a material which is softer than the material of the clamping plates and/or of the plate connectors.

39. The end fastening device as claimed in claim 23, wherein:
the clamping plates have in each case at least two through-holes for screw fastenings in both lateral end portions and have one or more additional through-holes for screw fastenings between the end portions along the principal direction; and/or
the plate connectors have at least two, preferably three through-holes for screw fastenings, which are preferably arranged for aligned arrangement with corresponding through-holes for screw fastenings in the clamping plates.

40. The end fastening device as claimed in claim 23 for fastening at least two envelopes in superposed layers, comprising at least three clamping plates arranged one above the other, wherein on the middle clamping plate in the mounted state strain relief elements are retained on both sides.

41. A line guide device for lines, for clean room applications, comprising:
at least one elongate, flexible envelope which is displaceable to-and-fro, and comprises a number of duct-like sheaths for lines, the sheaths extending in a longitudinal direction from a first end to a second end;
a first end fastening device for the first end and a second end fastening device for the second end of the envelope;
wherein the first end fastening device and/or the second end fastening device is an end fastening device as claimed in claim 23.

42. A modular building kit for producing end fastening devices as claimed in claim 23, comprising:
at least one flat clamping plate;
at least two different types of strain relief element within each case different structural heights and in each case connection portions of identical construction for securing to the clamping plate at least in a longitudinal direction;
at least two different types of plate connector with different structural heights, wherein each plate connector has two opposing clip portions of identical construction, which in each case interact at least form-fittingly with an end portion of the flat clamping plate.

43. The modular building kit for end fastening devices as claimed in claim 42, wherein
the clamping plate in each case has at least one retaining portion with a profile cross-section with undercut; and
each strain relief element in each case has a connection portion in order to retain the strain relief element on the clamping plate by engaging behind the undercut of the profile cross-section in the direction perpendicular to the major face of said clamping plate.

44. The device or building kit as claimed in claim 23, wherein the strain relief elements project in the longitudinal direction or perpendicular to the principal direction of the clamping plates beyond the clamping plates on both sides and preferably grip at least in part around the respective end face of the clamping plate.
